(19) United States
(12) Patent Application Publication
(10) Pub. No.: US 2012/0207320 A1
(43) Pub. Date: Aug. 16, 2012

(54) EARPHONE WITH TOGGLE MECHANISM

(76) Inventor: Elad Avital, Ramat Gan (IL)

(21) Appl. No.: 13/500,632

(22) PCT Filed: Oct. 3, 2010
(86) PCT No.: PCT/IL2010/000794

§ 371 Date: Apr. 5, 2012

Related U.S. Application Data
(60) Provisional application No. 61/272,648, filed on Oct. 15, 2009.
(60) Provisional application No. 61/301,253, filed on Feb. 4, 2010.

(51) Int. Cl. H04R 1/10

(52) U.S. Cl. 381/74; 381/373

(57) ABSTRACT

An earphone comprising a moving part, adapted to close an auditory port thereby toggling the earphone from an open mode allowing environmental sounds to reach an ear of the user to a closed mode blocking the ear of the user. The closing is accomplished while the earphone is in operation. The sound capsule of the earphone may also be activated and deactivated according to the mode of the earphone.

This patent application claims the benefit of U.S. Provisional Patent Application No. 61/272,648 filed 15 Oct., 2009 and U.S. Provisional Patent Application No. 61/301,253 filed 4 Feb., 2010.

### FIELD OF THE INVENTION

The present invention is related to the field of earphones and headsets, more particularly, the invention is related to the field of mechanics and electro-mechanics for providing a mechanism to allow a user to hear or block sound sources including a speaker and environmental sounds.

### BACKGROUND OF THE INVENTION

Earphones are widely used for listening to audio sources for recreation. In the professional audio sector, earphones are used in live situations by disc jockeys with a DJ mixer and sound engineers for monitoring signal sources. In radio studios, DJs use a pair of earphones when talking to the microphone while the speakers are turned off, to eliminate acoustic feedback and monitor their own voices. In studio recordings, musicians and singers use earphones to play along with a backing track. In the military, audio signals of many varieties are monitored using earphones.

Generally, earphones can be divided into two categories: Extra-aural earphones, which fit over an ear (for example circumaural earphones having a cup that surrounds the ear of a listener and supra-aural earphones having a pad that sits on top of the ear) and intra-aural earphones, which are inserted more or less deeply into the outer ear.

Earphones may be held near the ear by headpiece (for example a headband), by over-the-ear clips or simply by friction due to insertion into the outer ear canal. Earphones may be incorporated into protective equipment such as helmets, rain hats, or winter clothing (for example ear muffs or warm hats).

Earphones can be used both with fixed equipment such as CD or DVD players, home theater, personal computers and with portable devices (e.g., digital audio player/mp3 player, mobile phone, etc.). Cordless earphones do not need to be connected via a wire, receiving a radio or infrared signal encoded using a electromagnetic transmission link, for example infra-red, FM, Bluetooth or Wi-Fi. Wired earphones are attached to an audio source. The most common connectors are ¼″ and 3.5 mm stereophonic jack plugs and sockets.

Earphones are widely used for listening to audio sources for recreation.

Audio signals from personal audio equipment often must compete with environmental sounds for the attention of a user. Sometimes environmental sounds are a distraction, at other times environmental sounds may include information that is of importance and at other times, high volume environmental noise may endanger hearing. Thus, sometimes an individual will desire to block out some or all environmental sounds and at other times, the user may desire to hear environmental sounds with unblocked acuity.

The need to sometimes protect some individuals from environmental noise and give other individuals clear access to environmental sounds has driven the development of various forms of earphones which block environmental noise to varying degrees. For example circumaural earphones have been developed with an open or closed earcup to respectively permit or obstruct environmental sounds reaching the listener. Open circumaural earphones, have an open grille on the back of the earcup, exposing the driver to the outside and allowing the listener to hear outside sounds. Closed, circumaural earphones have a sealed backing, which attenuates background sounds, providing a level of isolation to the listener. In addition, sound from open circumaural earphones can be heard by others in the vicinity of the user, while closed circumaural earphones provide privacy. Open circumaural earphones usually have less distortion than closed circumaural earphones due to earcup resonance. Also, intra-aural earphones have developed into two forms. The first is an earbud that does not fully entirely fill the ear canal and the second form is a canalphone that acts as an earplug, blocking out environmental noise.

For Example, FIG. 1 illustrates a prior art headset including earphone 100a and earphone 100b. FIG. 1 also illustrates a headpiece 102 and a connecting cord 104.

None of the above prior art fully serves the needs of a user of earphones and ear-protection equipment who sometimes needs to be protected from environmental noise and at other times desires to hear unobstructed sounds in the external environment.

For example, in the performing arts, performers (for example DJs, musicians, actors) and production staff (for example, stage crews, set crews, directors and their staff and sound technicians) often need to be protected from environmental noise in order to concentrate on producing a precise audio signal. On the other hand, performers and production staff often need to have uninhibited communication with an audience or other members of the production staff or to understand how the sound being produced is interacting with the ambient acoustics and therefore they need uninhibited access to environmental sounds. As a result, today, performers and production staff often wear high-quality, closed circumaural earphones and are forced to manually put on the phones to block environmental sounds, and then to remove the phones when there is a need to hear environmental sounds. In these cases the need to put on and remove earphones can be a significant nuisance to a performer or production technician whose hands are busy playing a musical instrument or controlling production equipment.

Command/control personnel (for example, staff of military command and control centers or ship control command rooms or aircraft cockpits, personnel controlling robots and drones, air-traffic controllers, ground controllers, dispatchers at police/fire/rescue switchboards and the like) receive audio signals from the field. Sometimes, these staff need to concentrate on quickly changing field situations. At other times, these staff need to participate in planning and coordination with other members of the control center. Thus, sometimes these staff need to be insulated from environmental sounds and to listen only to field communications over earphones, sometimes they need to monitor sounds in the field (transmitted through their earphones) while participating in local communication in the control room, and sometimes they need to concentrate on that which is being discussed in the command/control room.

Field personnel (for example, security personnel, rescue crews, police, firefighters, commandos [including reconnaissance, special forces, or engineering units], platoon commanders or communications officers) often need to switch between concentration on communication over earphones with protection from environmental noise and acute hearing of the sounds in the local environment (for example to detect, locate or identify local threats, resources or targets). These personnel often need to concentrate on challenging physical tasks and do not have a spare hand to put on or remove earphones. Furthermore, protective equipment like gloves and helmets or dirty/dangerous substances, which a worker may be handling or the need to keep one's hands sanitized during a medical procedure may make it impossible for a field worker to put on or remove his earphones.

Also, vehicle operators, motorcyclists (for example commuters, messengers, motorcycle police) heavy equipment operators, manufacturing workers, construction workers, food processing and health workers may wear earphones or helmets and require intermittent protection from environmental noise. Yet these workers may not be able to reach up and adjust earphones because their hands may be busy running equipment, dirty or covered by heavy gloves. They may also need to keep their hands clean/aseptic and this may prevent them from adjusting earphones. The solution offered by the present invention allows such workers and drivers to speak on the phone as if they are equipped with a hands free telephone which is integrated inside their earphones or helmets.

One previous art solution for allowing unobstructed access to some environmental sounds while protecting an operator from environmental noise is called active sound cancelling using destructive interference. For example, US patent application number 2009/0041260 A1 to Jorgensen et al. describes such a system. In general, active sound cancelling is very effective for allowing clear auditory access to the environment while cancelling constant fixed frequency noise (like that of a noisy machine), but active sound cancellation is not effective at blocking noise that varies significantly in time or frequency. Active sound cancelling systems are expensive, technically complex and are prone to breakdown and failure (which in many situations described above could lead to disaster). Furthermore, sound cancellation equipment—if improperly adjusted—can distort desired sounds or produce feedback at volumes that are distracting or even dangerous.

An alternative prior art solution to selective blocking of environmental noise is to passively block all environmental noise while providing a microphone to selectively transmit artificially reconstructed environmental sounds to an earphone loudspeaker. U.S. Pat. No. 6,801,629 to Brimhall et al. describes such a system. A drawback of systems employing artificially reconstituted environmental sounds is that the quality of the artificial sounds is not as good as the true sound. This loss of fidelity may be unacceptable to discriminating performers and production staff. In the case of field workers, loss of fidelity may prevent a worker from locating a noise source, for example a trapped victim who cannot be seen, or an enemy combatant. In addition, such a solution increases the costs of the system.

Isvan US published patent application 2010/0008528 has suggested use of a dual mode earphone that can be switched from a mode for allowing the user to hear environmental noise to a mode to block environmental noise. Nevertheless, the dual mode intra-aural earphone of Isvan must be removed from the ear (and thus be non-operational) and manually switched, requiring fine motor manipulation. As has been stated earlier, it is not always possible for a user to stop working and concentrate on switching his earphones every time that he wants to switch between protection from background noise and hearing of the external environment.

U.S. Pat. No. 6,826,287 to Myers (Myers '287) and U.S. Pat. No. 4,529,057 to Telford (Telford '057) disclose a circumaural earmuff with vents to allow a user to momentarily open the earmuff to the external environment for short term communication. The device of Myers '287 allows limited hearing of external noise with minimal loss of protection. The vents of Myers '287 are small and open only with the active involvement of the user (in the preferred embodiment the vents are biased closed). The device of Myers '287 requires a user's attention and occupies his hands in order to open or close the vents.

Telford '057 suggests two technical methodologies for opening and closing the vent of an earmuff 1) a removable cap and 2) a slotted, linearly sliding vent cover displaced by means of a handle. Both methodologies require fine motor manipulation (grasping and pulling or pushing a small handle or cover with ones fingers) in order to open or close the vent. Thus neither the device of Myers '287 nor that of Telford '057 supplies a solution for a worker who must switch between hearing environmental sounds and insulation from environmental sounds without distracting his attention to other matters or without taking his hands from another task.

U.S. Pat. No. 5,729,605 to Bobisuthi et al. (Bobisuthi '605) discloses a circumaural earphone whose frequency response can be adjusted using specially designed vents in the earcup. The device of Bobisuthi '605 has finally adjusted frequency response requiring the attention of a user and fine motor manipulations (using fingers to precisely adjust the vents in order to achieve the desired response). While certain settings of the device of Bobisuthi '605 might adjust a user's ability to hear environmental sounds, it certainly does not supply a convenient hands free device that can be used by busy workers requiring alternating protection from and access to environmental sounds.

There is thus a long-recognized need for a single device that can sometimes provide protection from environmental noise and at other times, allow the user to hear environmental sounds without undue attention of a user. The current invention supplies such a system.

### DEFINITIONS

The following terms are used in this application in accordance with their plain meanings, which are understood to be known to those of skill in the pertinent art(s). However, for the sake of further clarification, in view of the subject matter of this application, the following explanations, elaborations and exemplifications are given as to how these terms may be used or applied herein. It is to be understood that the explanations, elaborations and exemplifications below are to be taken as exemplary or representative and are not to be taken as exclusive or limiting. Rather, the terms discussed below are to be construed as broadly as possible, consistent with their ordinary meanings and the discussion below.

A headphone is a listening device worn by a listener, which includes one or two earphones and is configured to retain the earphone(s) in close proximity to the listener's ear(s).

An earphone is a listening device configured to be held or worn close to a listener's ear or within the listener's outer ear; an earphone includes a small loudspeaker and also including a means for connecting the loudspeaker to a signal source such as an audio amplifier, telephone, radio or CD player.

A circumaural earphone is an earphone that includes an earcup that surrounds a user's ear.

An open circumaural earphone is a circumaural earphone wherein the earcup is perforated allowing environmental sounds to reach a user's ear.

A closed circumaural earphone is a circumaural earphone wherein the earcup is closed, preventing environmental sounds from reaching a user's ear.

An earbud is an intra-aural earphone that does not block the auditory canal of the user and allows the user to hear environmental sounds.

A canalphone is an intra-aural earphone that blocks the auditory canal of the user and attenuates environmental noise reaching the user.

A supra-aural earphone is an earphone that sits on the outer ear of a user.

An extra-aural earphone is an earphone that is retained outside of the ear of a user.

An intra-aural earphone is an earphone that is retained inside of the outer ear of a user.

A headset includes at least one earphone and a microphone installed into a headpiece designed to permit hands-free two way audio communication via an electronic device.

A fine motor manipulation is manually handling an object in a way that requires precise control of movement including precise limitation of movement, precise limitation of force, movement of small muscle groups or coordination between muscle movement and senses (e.g eye hand coordination). Example of fine motor manipulations include manipulating small objects (pushing a button, twisting a knob), using the pincer grasp (thumb and forefinger), transferring an object from hand to hand, handling a delicate object that can be broken by manual force without exertion and eye-hand coordination tasks.

A gross motor manipulation is a manual handling of an object that does not employ a fine motor manipulation.

### SUMMARY OF THE INVENTION

Various methods and systems are possible for protecting a user of an earphone from environmental noise. Particularly, a system or method may have an acoustic port to allow the wearer to hear environmental sounds and the system may also include a moving part configured to move from a closed mode (blocking the acoustic port and preventing environmental noise from entering the ear of the user) to an open mode (not blocking the acoustic port and allowing the user to hear environmental sounds).

An embodiment of an earphone for transmitting an audio signal to a user may include an acoustic port for allowing an environmental sound to enter an ear of the user. The earphone may also include a movable part configured for moving from an open mode to a closed mode. In the closed mode the acoustic port may be closed attenuating the environmental sound reaching the ear of the user and in the open mode the acoustic port may be open allowing the environmental sound to reach the ear of the user with minimal attenuation. The movable part may be configured for moving without a fine motor manipulation by the user.

In an embodiment of an earphone the movable part may be configured for moving due to a force exerted by the user.

In an embodiment of an earphone the movable part may be configured for moving due to a force exerted by a shoulder of the user.

An embodiment of an earphone may further include an earplug.

An embodiment of an earphone may further include a sound capsule and a switch for activating the sound capsule automatically when the movable part moves from the open mode to the closed mode.

An embodiment of an earphone may further include a second sound capsule synchronized with the first sound capsule such that activating of the first sound capsule also results in activating the second sound capsule.

In an embodiment of an earphone the switch may also automatically deactivate the sound capsule when the movable part moves from the closed mode to the open mode.

An embodiment of an earphone may further include a second sound capsule synchronized to the first sound capsule such that deactivating of the first sound capsule also results in deactivating the second sound capsule.

In an embodiment of an earphone the movable part may swing on a hinge.

In an embodiment of an earphone the movable part may be configured for moving from the closed mode to the open mode while the earphone remains on an ear of the user.

In an embodiment of an earphone the movable part may be configured for moving from the open mode to the closed mode while the earphone remains on an ear of the user.

An embodiment of an earphone may further include an actuator and the moving of the movable part may be by a force exerted by said actuator.

In an embodiment of an earphone the actuator may be triggered by an inertial switch, an electromagnetic transceiver, an electrostatic detector, a hard wired switching mechanism, a sound activated switch, a volume detector or a remote control ring.

An embodiment of an earphone may further include a microphone and an algorithm to process a voice command received from the user over the microphone. The force exerted by the actuator may be controlled by the voice command of the user.

A method for allowing an environmental sound to enter an ear of a user wearing an earphone may include the steps of supplying the user with an earphone having an open mode in which an acoustic port allows environmental sound to enter the ear with minimal attenuation. The earphone may be toggled from the open mode to a closed mode while the earphone remains in position on the user without employing a fine motor manipulation of the user.

A method for allowing an environmental sound to enter an ear of a user wearing an earphone may further include inserting the earphone into an outer ear canal of the user.

In a method for allowing an environmental sound to enter an ear of a user, the toggling of the earphone from a closed mode to an open mode may occur automatically upon receiving a call to the user, firing of a weapon, broadcasting of a close command, speaking of a voice command or passing of an environmental noise level beyond a threshold.

In a method for allowing an environmental sound to enter an ear of a user the toggling may by triggered by moving of the head of the user or a sending of a signal by a command/control personnel.

In a method for allowing an environmental sound to enter an ear of a user the supplying of an earphone may include installing the earphone into a military helmet, installing the earphone into a bicycle helmet or installing said earphone into a motorcycle helmet.

A method for allowing an environmental sound to enter an ear of a user may further include activating a sound capsule of the earphone when the earphone is toggled from the open mode to the closed mode.

In a method for allowing an environmental sound to enter an ear of a user, activating the sound capsule may be synchronized with an activating of a second sound capsule.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 shows an exemplary prior-art headset;

FIG. 2 is a schematic drawing of a first embodiment of a circumaural earphone in the open mode;

FIG. 3 is a schematic drawing of the first embodiment of a circumaural earphone in a closed mode.

FIG. 4 is a schematic drawing of a second embodiment of a circumaural earphone in an open mode;

FIG. 5 is a schematic drawing of a third embodiment of a circumaural earphone in an open mode;

FIG. 6A is a schematic drawing of a first view of a fourth embodiment of an intra-aural earphone in an open mode;

FIG. 6A1 is a schematic drawing of a second view of the fourth embodiment of an intra-aural earphone in an open mode;

FIG. 6B is a schematic drawing of a first view of the fourth embodiment of an intra-aural earphone in a closed mode;

FIG. 6B1 is a schematic drawing of a second view of the fourth embodiment of an intra-aural earphone in a closed mode.

FIG. 7A is a schematic drawing of a cutaway view of the fifth embodiment of a circum-aural earphone in an open mode.

FIG. 7B is a schematic drawing of a cutaway view of the fifth embodiment of a circum-aural earphone in a closed mode.

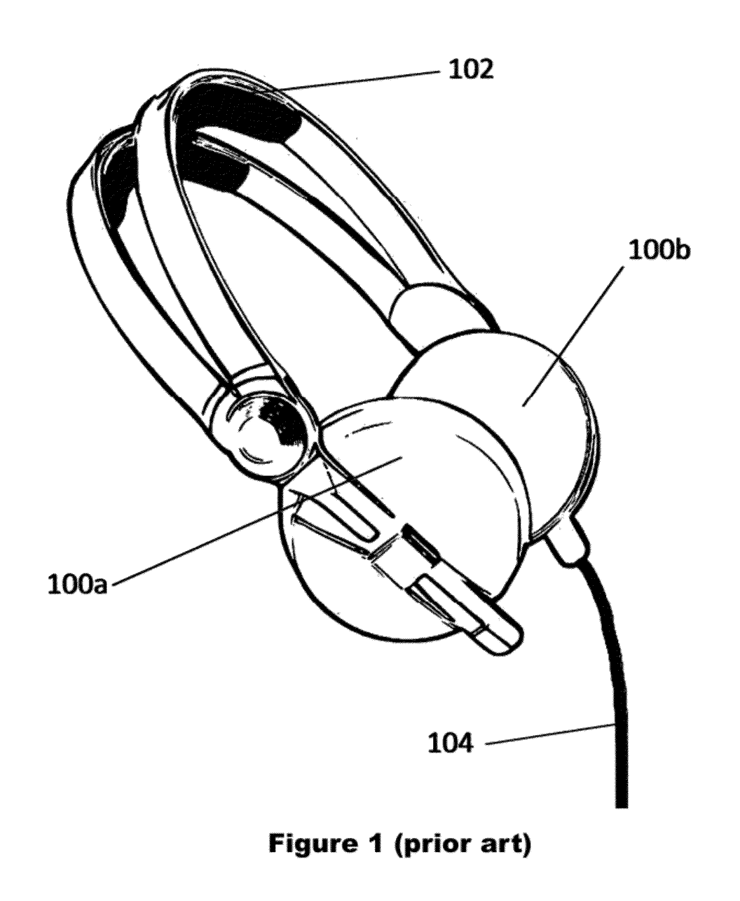

### DETAILED DESCRIPTION OF PREFERRED EMBODIMENTS

In the following detailed description, numerous specific details are set forth regarding the apparatus and method, in order to provide a thorough understanding of the present invention. It will be apparent, however, to one skilled in the art that the present invention may be practiced without such specific details. In other instances, well-known components, structures and techniques have not been shown in detail to avoid unnecessarily obscuring the subject matter of the present invention. Moreover, various examples are provided to explain the operation of the present invention. It should be understood that these examples are exemplary. It is contemplated that there are other methods and systems that are within the scope of the present invention. Also, the same reference numerals are used in the drawings and in the description to refer to the same elements to simplify the description.

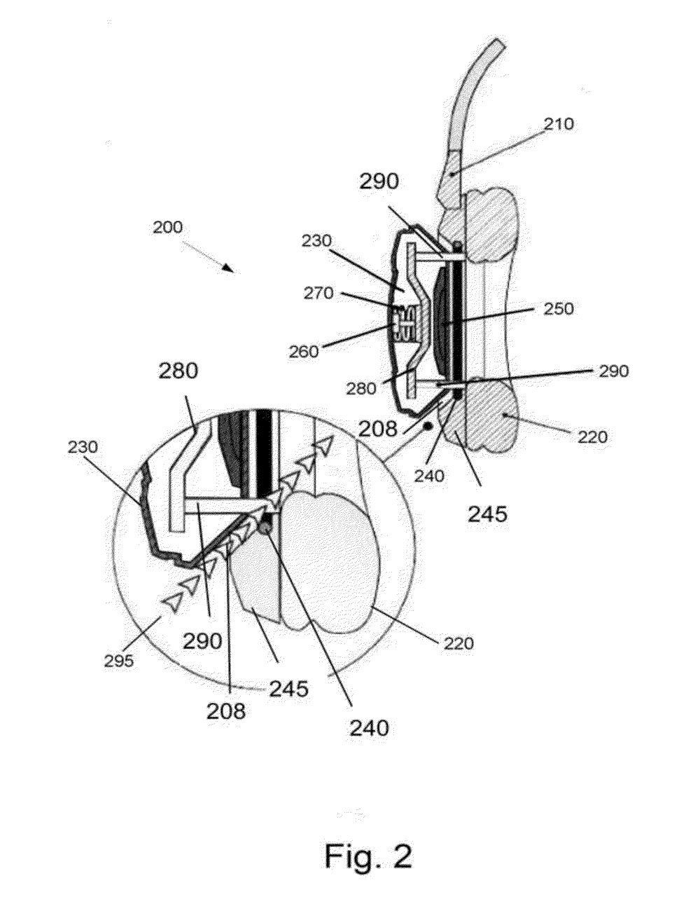

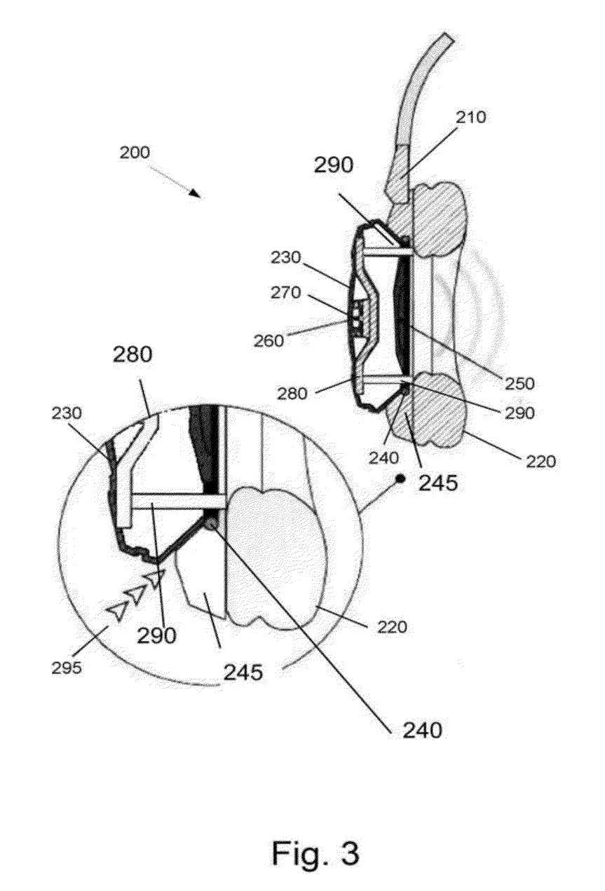

FIG. 2 illustrates an earphone 200. Earphone 200 includes a hands-free toggle mechanism for alternately opening and closing earphone 200 and turning on or off (activating and deactivating) the sound capsule. When earphone 200 is in the open mode (as illustrated in FIG. 2) earphone 200 performs as an open circumaural earphone permitting a wearer to hear outside sounds. When earphone 200 is in the closed mode (as illustrated in FIG. 3) earphone 200 performs as a closed circumaural earphone protecting a wearer from outside sounds. Earphone 200 may be useful to professional users, such as DJs, who may wish to monitor external sounds (with earphone 200 in the open mode) and then quickly return earphone 200 to the closed mode and reactivate the speaker for cuing the next track, without needing to put on or remove earphone 200 and without using their hands, which are otherwise occupied.

Earphone 200 includes a standard connector 210 for connecting to a headpiece, an ear pad 220, an ear cup 230 and an O-ring 240 mounted on a resilient base ring 245.

Ear cup 230 includes a sound capsule 250 and a toggle mechanism 260. One end of a spring 270 is connected to ear cup 230, and the other end of spring 270 is attached to a switch base 280. Switch base 280 is connected to a first end of tracks 290. Tracks 290 are connected on their other end to resilient base ring 245 of ear pad 220. During operation of earphone 200, ear cup 230 is movable with respect to resilient base ring 245 of ear pads 220. During operation of earphone 200, resilient base ring 245 of ear pad 200 is held substantially fixed in respect to the ear of the user.

In the enlarged bubble of FIG. 2, it is illustrated that when earphone 200 is in the open mode, earphone 200 is open to outside sounds 295, penetrating through an acoustic port 208 between ear cup 230 and resilient base ring 245 of ear pads 220.

FIG. 3 is a schematic drawing of earphone 200 in the closed mode.

As can be seen in the enlarged bubble of FIG. 3, in the closed mode, earphone 200 is closed to outside sounds 295, due to closing of the acoustic port 208 between ear cup 230 and resilient base ring 245 of ear pads 220.

In operation, when a user wishes to open earphone 200 to outside sounds 295, he may use his shoulder to push toggle mechanism 260. Pushing toggle mechanism 260 when ear cup 230 is initially in the closed position (FIG. 3), releases a latch allowing spring 270 to unwind, sliding ear cup 230 away from resilient base ring 245 of ear pad 220, along tracks 290 opening acoustic port 208 between ear cup 230 and resilient base ring 245 of ear pads 220 placing earphone 200 in an open mode and allowing outside sounds to penetrate.

When the user wishes to return earphone 200 to the closed mode he may use his shoulder again to push the toggle mechanism 260, which is initially in the open position (as illustrated in FIG. 2), pressure from the user's shoulder contracts spring 270, pushing ear cup 230 back towards resilient base ring 245 of ear pad 220. Ear cup 230 slides back along tracks 290, and acoustic port 208 between ear cup 230 and resilient base ring 245 is closed, attenuating outside sounds reaching the ear.

It is understood that although earphone 200 is manually operated, it is within the scope of the present invention to include a servo motor to automatically move capsule housing 230 between the open and closed modes. A user could control the servo (opening and closing the earphone) either by switching on or off a DC power source for a hard wired version, or by using a remote control (for example a Bluetooth remote control unit including a remote control ring that could itself include a user interface such as an inertial switch or a conventional button or a voice activated switch) or via an inertial switch internal to the earphone (by which the user could open or close the earphone via movements of his head).

While earphone 200 is shown with standard connector 210 for connecting to a headpiece (for example a headband), alternate embodiments could be made without including standard connector 210 and wherein earphone 210 would be installed into a helmet (for example a bicycle helmet or a military helmet or a motorcycle helmet).

It is understood that in all the alternative embodiments as described above switching of earphone 200 between open and closed modes is achieved while earphone remains in position over the user's ear and remains operational (capable of transmitting sounds to the user).

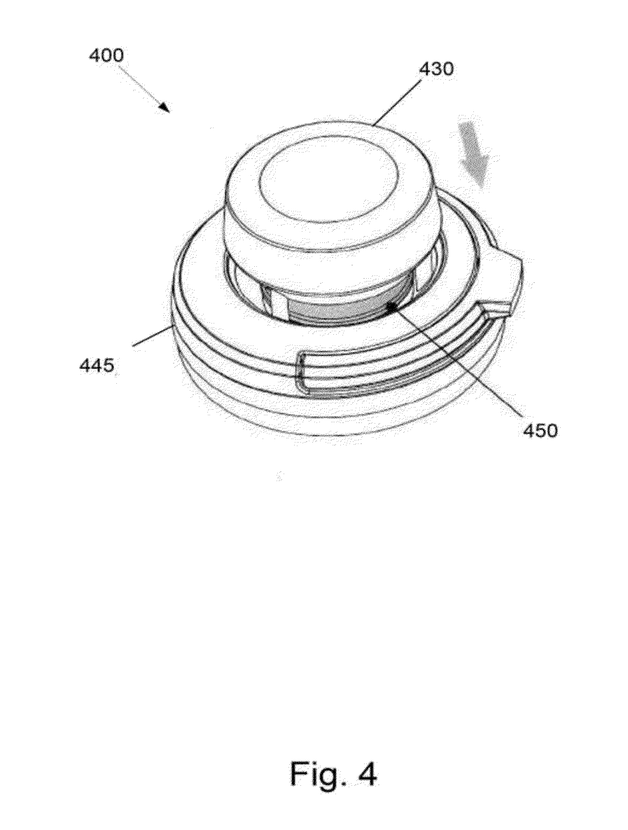

FIG. 4 is a schematic drawing of another embodiment of a toggle mechanism to open and close an earphone 400. The toggle mechanism of earphone 400 operates in a similar manner to the mechanism of earphone 200, except that a sound capsule 450 of earphone 400 is mounted to a resilient base ring 445 which is held immobile with respect to the user's ear, instead of being mounted to an ear cup 430 which moves in respect to the ear of the user.

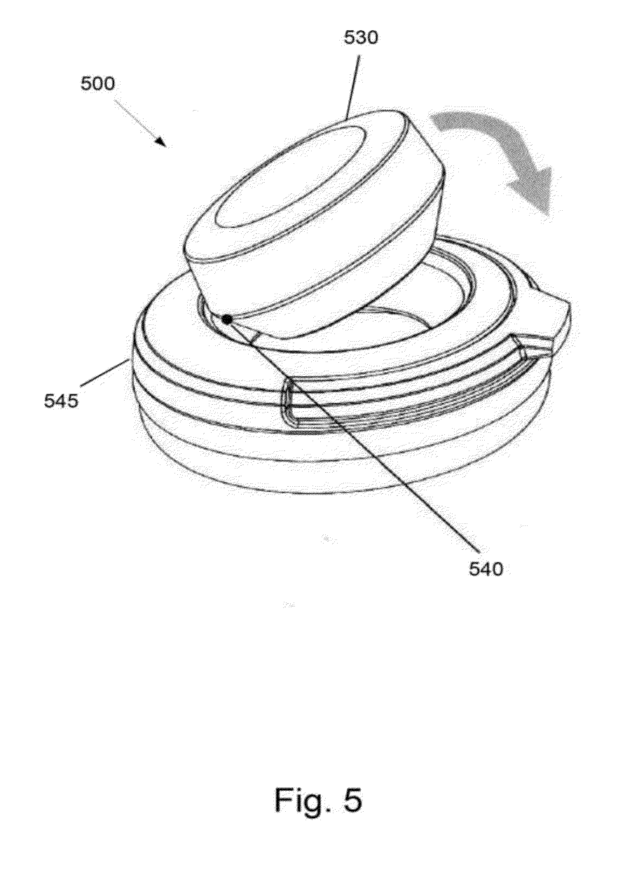

FIG. 5 is a schematic drawing of yet another embodiment of a toggle mechanism to open and close an earphone. Earphone 500 operates in a similar manner to earphone 200, except that earphone 200 is opened and closed by swinging ear cup 530 on a hinge 540 like a house door. In earphone 500, the sound capsule may be mounted either to resilient base ring 545 or to ear cup 530.

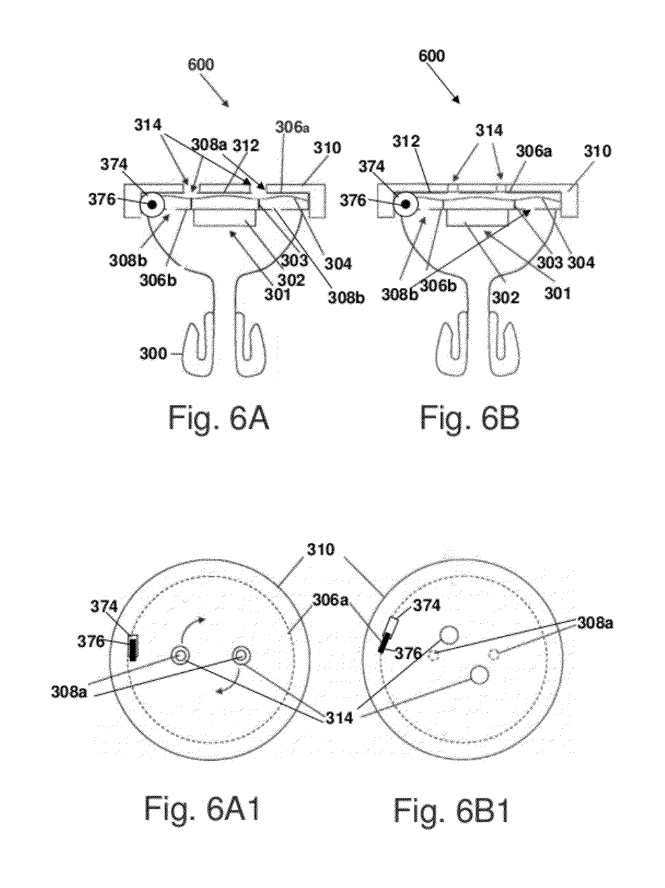

Reference is now made to FIGS. 6A-6B and 6A1-6B1, which illustrate sectional views and front views of an earphone 600. A rotating cap 310 slides along a sealing surface 312. Sealing surface 312 is coupled to speaker 301. While earphone rotating cap 310, moves between an open mode and a closed mode such that acoustic apertures 314 are aligned with front acoustic ports 308a in the open mode (FIGS. 6A and 6A1) and acoustic apertures 314 are not aligned with front acoustic ports 308a in the closed mode (FIGS. 6B and 6B1).

Speaker 301 includes a magnet 302 and a voice coil 303 behind a diaphragm 304 housed between a front cover 306a and a back cover 306b (in an alternate embodiment, speaker 301 may not include a magnet or a voice coil). Front cover 306a includes front acoustic ports 308a and back cover 306b includes back acoustic ports 308b.

Earphone 600 also includes an actuator including a piston 374 and a drive rod 376. Piston 374 is connected to rotating cap 310 while drive rod 376 is connected to front cover 306a. When drive rod 376 is retracting into piston 374 (as shown in FIG. 3A1) rotating cap 310 is in the open position. When piston 374 is connected to a positive current, a magnet drives drive rod 376 out of piston 374 pushing rotating cap 310 with respect to front cover 306a forcing rotating cover 310 to rotate with respect to front cover 306a the rotation moving rotating cap 310 into the closed mode thereby closing acoustic port 308a. When a negative current is applied to piston 374, the magnet draws drive rod 376 into piston 374 thereby pulling rotating cap 310 and causing it to rotate into the open mode.

As noted above, in this embodiment, rotating cap 310 is movable between an open position (FIGS. 6A and 6A1) in which front acoustic ports 308a and acoustic apertures 314 are aligned providing a pathway for sound, and a closed position in which rotating cap 310 closes front acoustic ports 308a by sealing against rotating cap 310 and acoustic apertures 314 are sealed against the front cover 306a (FIGS. 6B and 6B1).

Earphone 600 is designed to be hard wired to an external signal source and a switched power source to drive speaker 301 and piston 374 respectively. The power source switch could be operated for example by a button or by a microphone with a voice activation circuit and appropriate software or by a remote control or by an inertial switch or by an electrostatic detector or by a volume detector. In an alternative embodiment, earphone 600 may include an internal power source (for example a hearing aid battery) and be connected to a switching source by an electromagnetic transceiver (for example a Bluetooth transceiver, a radio transceiver or an infra-red transceiver) to receive signals and to toggle between the open and closed modes. Similarly, earphone 600 could include an internal sensor (for example a microphone or an inertial sensor). For example, when earphone 600 includes an inertial sensor, then the user would toggle earphone 600 between the open and closed modes by shaking his head or a like movement.

In further embodiments there may be a second earphone which also includes a closable acoustic port. In such an embodiment the toggling mechanism may be configured to synchronize opening and closing of the acoustic ports of the two earphones.

In further embodiments, the opening and closing mechanism of earphone 600 could be installed in a circum-aural earphone held to the ears of a user by a headband or by a helmet or the like.

In an alternative embodiment, the volume of the loudspeaker may be adjusted automatically upon opening or closing the earphone. The magnitude of the automatic volume change may be adjustable by the user. For example, a user may want the volume reduced when the earphone is open (under the assumption that the user opens the earphone when he wants to hear environmental sounds and not the loudspeaker); alternatively the volume may be increased when the earphone is open (under the assumption that when the earphone is open, the speaker signal will need to compete with background noise). In addition, the intensity of the sealing of the acoustic port may be used to control the attenuation of the environmental sounds.

Alternatively, a third party may also control opening and closing of an earphone. For example a helicopter pilot may remotely open the earphone of a rescue worker when the rescue worker reaches the vicinity of a victim seeking help, or close the earphone when the pilot begins to winch up the rescue worker into the helicopter. Similarly, when control personnel in a command/control room detect that a reconnaissance commando did not receive a message, the control personnel may close the earphones of the reconnaissance commando. When the control personnel knows that a cannon is to be shot towards a target, the control personnel may send a broadcast closing all friendly earphones in the vicinity of the target. A similar broadcast mechanism may be useful for police, closing the earphones of all police in the vicinity when using audio riot control measures. In another example, a broadcast signal might be sent to close earphones of all the sailors on a boat immediately before firing a weapon (for example discharging the boat's cannon) or to close earphones of workers at a mining site immediately before blasting a hole.

Alternatively, certain events might lead to automatically opening or closing an earphone. For example, a monaural earphone of a driver may close automatically when a phone call is received. Similarly an earphone may close automatically when an environmental noise level reaches a certain threshold.

It is understood that in all the alternative embodiments of earphone 600 described above, toggling of the earphone between open and closed modes is achieved while the earphone remains in position in the user's outer ear canal and remains operational (capable of transmitting sounds to the user).

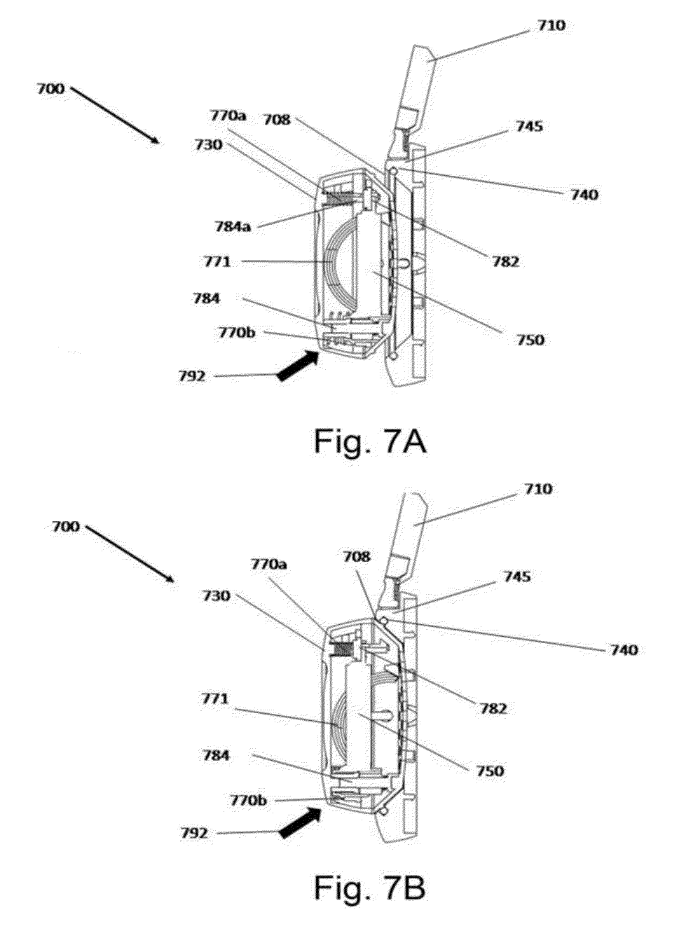

FIG. 7A is a schematic drawing of a cutaway view of the fifth embodiment 770 of an earphone 700 in an open mode. Earphone 700 includes a hands-free toggle mechanism for alternately opening and closing earphone 700. When earphone 700 is in the open mode (as illustrated in FIG. 7A) earphone 700 performs as an open circum-aural earphone permitting a wearer to hear outside sounds. When earphone 700 is in the closed mode (as illustrated in FIG. 7B) earphone 700 performs as a closed circum-aural earphone protecting a wearer from outside sounds. Earphone 700 may be useful to professional users, such as DJs, who may wish to monitor external sounds (with earphone 700 in the open mode) and then quickly return earphone 700 to the closed mode for cuing the next track, without needing to put on or remove earphone 700 and without using their hands, which are otherwise occupied.

Earphone 700 includes a standard connector 710 for connecting to a headpiece, an ear cup 730 and an O-ring 740 mounted on a resilient base ring 745 for an ear pad (not shown).

Earphone 700 includes a sound capsule 750 which includes an on/off switch 782 for activating/deactivating sound capsule 750. Alternatively, activating sound capsule 750, may include manipulating the volume of the transmitted sound. For example, when switching to open mode, transmitted sound may be lower in accordance with the user's preferences (users preferences may be set by a potentiometer or any other kind of interface provided for that purpose).

Earphone 700 includes a toggle mechanism similar to the toggle mechanism of a standard ball point pen and well known to those skilled in the art. The toggle mechanism is connected to a sliding post 784 (which slides up and down in the toggle mechanism like the cylindrical ink tube of a ballpoint pen) and second spring 770b.

Ear cup 730 is movable with respect to resilient base ring 745. During operation of earphone 700, resilient base ring 745 is held substantially fixed in respect to the ear of the user. Earphone 700 also includes a distributer arm 771 which distributes force such that when a user pushes the bottom of earphone 700 with his shoulder in a direction and location indicated by arrow 792 the force is transformed into a an inward force on ear cup 730.

When earphone 700 is in the open mode, earphone 700 is open to outside sounds, penetrating through an acoustic port 708 between ear cup 730 and resilient base ring 745. Spring 770b holds the earphone open and spring 770b also holds spring 770a away from switch 782. Holding spring 770a away from switch 782 causes switch 782 to be turned off and deactivates sound capsule 782. Sound capsule 782 may synchronized to a second sound capsule located in a second earphone (earphone 700 is configured to fit one ear of the user and the second earphone is configured to fit the other ear of the user) such that when sound capsule 750 is activated, the second sound capsule is also activated and when sound capsule 750 is deactivated, the second sound capsule is also deactivated.

When earphone 700 is in the open mode (illustrated in FIG. 7A) a light push of the users shoulder in the direction and location of arrow 792 will push spring 770a against switch 782 turning on switch 782 and activating sound capsule 750 (and may synchronously activating a second sound capsule located on the other ear of the user) without closing earphone 700 or setting off the toggle mechanism. Thus, with a light push of the shoulders the user can activate sound capsule 750 while earphone 700 remains in the open mode. This allows the user to hear both the audio output of sound capsule 750 and environmental sounds at the same time.

In operation, when a user wishes to close earphone 700 to outside sounds, he uses his shoulder to push hard against ear cup 730 in the direction and location indicated by arrow 792. This causes the sliding of ear cup 730 along with sliding post 784 closing earphone 770 and latching the toggle mechanism. Closing the earphone pushes ear cup 730 against O-ring 740 thereby insulating the ear of the user from environmental sounds. Simultaneously movement of sound cup 730 pushes spring 770a against switch 782 thereby activating sound capsule 750 so that when earphone 700 closes, sound capsule 750 automatically resumes providing an audio signal.

FIG. 7B is a schematic drawing of a cutaway view of the fifth embodiment of a circum-aural earphone in a closed mode. In the closed mode, earphone 700 is closed to outside sounds, due to closing of the acoustic port 708 between ear cup 730 and resilient base ring 745.

When ear cup 730 is initially in the closed position (FIG. 7B), and the user wishes to hear environmental sounds, the user uses his shoulder to push against ear cup 730 in the direction and location indicated by arrow 792. This releases the toggle mechanism allowing springs 770b to unwind. Spring 770b pushes sliding ear cup 730 away from resilient base ring 745, opening acoustic port 708 between ear cup 730 and resilient base ring 745 placing earphone 700 in an open mode and allowing outside sounds to penetrate. The outward movement of ear cup 730 also pulls spring 770a away from switch 782 turning off switch 782 and deactivating sound capsule 750 (and may also deactivating the second synchronized sound capsule located over the other ear of the user). With acoustic port 708 open and sound capsule 750 deactivated, the user has unhindered and undisturbed access to environmental sounds.

While the invention has been described with respect to a limited number of embodiments, it will be appreciated that many variations, modifications and other applications of the invention may be made. It will be appreciated that the above descriptions are intended only to serve as examples, and that many other embodiments are possible within the spirit and the scope of the present invention.

What is claimed is:

1) An earphone for transmitting an audio signal to a user comprising:
A) an acoustic port for allowing an environmental sound to enter an ear of the user;
B) a movable part configured for moving from an open mode to a closed mode, said closed mode for closing said acoustic port and said open mode for opening said acoustic port, and wherein said movable part is configured for said moving without a fine motor manipulation by the user.

2) The earphone of claim 1, wherein said movable part is configured for said moving due to a force exerted by the user.

3) The earphone of claim 2, wherein said movable part is configured for moving due to a force exerted by a shoulder of the user.

4) The earphone of claim 1, further comprising:
C) an earplug.

5) The earphone of claim 1, further comprising:
C) a sound capsule, and
D) a switch for activating said sound capsule upon said moving of said movable part from said open mode to said closed mode.

6) The earphone of claim 5, further comprising:
E) a second sound capsule and wherein said activating of said sound capsule is synchronized to an activating of said second sound capsule.

7) The earphone of claim 5, wherein said switch is further configured for deactivating said sound capsule upon a motion of said movable part from said closed mode to said open mode.

8) The earphone of claim 7, further comprising:
E) a second sound capsule and wherein said deactivating of said sound capsule is synchronized to a deactivating of said second sound capsule.

9) The earphone of claim 1, wherein said movable part swings on a hinge.

10) The earphone of claim 1, wherein said movable part is further configured for moving from said closed mode to said open mode while the earphone remains on an ear of the user.

11) The earphone of claim 1, wherein said movable part is further configured for moving from said open mode to said closed mode while the earphone remains on an ear of the user.

12) The earphone of claim 1 further comprising
C) an actuator and wherein said moving due to a force exerted by said actuator.

13) The earphone of claim 12 wherein said actuator is triggered by a trigger selected from the group containing an inertial switch, an electromagnetic transceiver, an electrostatic detector, a hard wired switching mechanism, a sound activated switch, a volume detector and a remote control ring.

14) The earphone of claim 13, further comprising:
D) a microphone, and
E) an algorithm to process a voice command received from the user, said force exerted by said actuator being according to said voice command.

15) A method for allowing an environmental sound to enter an ear of a user wearing an earphone comprising:
A) supplying the user with an earphone having an open mode. for allowing environmental sound to enter the ear and
B) toggling the earphone from said open mode to a closed mode for attenuating, said environmental sound, said toggling while said earphone remains in position on the user and said toggling not employing a fine motor manipulation of the user.

16) The method of claim 15 further comprising:
C) inserting the earphone into an outer ear canal of the user.

17) The method of claim 15 wherein said toggling occurs automatically upon at least one event selected from the group containing; receiving a call to the user, firing of a weapon, broadcasting of a close command, speaking of a voice command and passing of an environmental noise level beyond a threshold.

18) The method of claim 15 wherein said toggling includes at least one action selected from the group containing a moving of the head of the user and a sending of a signal by a command/control personnel.

19) The method of claim 15 wherein said supplying includes at least one action selected from the group containing installing said earphone into a military helmet, installing said earphone into a bicycle helmet and installing said earphone into a motorcycle helmet.

20) The method of claim 15, further including the step
C) activating a sound capsule of the earphone

21) The method of claim 20, wherein said activating is synchronized with an activating of a second sound capsule.
